(19) United States
(12) Patent Application Publication
(10) Pub. No.: US 2013/0206186 A1
(43) Pub. Date: Aug. 15, 2013

(54) DISHWASHER APPLIANCE WITH A DAMPENING BAFFLE

(71) Applicants: Jing Shen Tang, Louisville, KY (US); John Alexander Gardner, Louisville, KY (US); Stephen Froelicher, Shepherdsville, KY (US); Alexander D. James, Louisville, KY (US); Larry E. Miller, Louisville, KY (US); Jonathan Charles Crosby, Louisville, KY (US); Christopher Styn, Louisville, KY (US)

(72) Inventors: Jing Shen Tang, Louisville, KY (US); John Alexander Gardner, Louisville, KY (US); Stephen Froelicher, Shepherdsville, KY (US); Alexander D. James, Louisville, KY (US); Larry E. Miller, Louisville, KY (US); Jonathan Charles Crosby, Louisville, KY (US); Christopher Styn, Louisville, KY (US)

(73) Assignee: GENERAL ELECTRIC COMPANY, Schenectady, NY (US)

(21) Appl. No.: 13/396,975

(22) Filed: Feb. 15, 2012

(51) Int. Cl. A47L 15/02; A47L 15/14; B08B 3/02

(52) U.S. Cl. 134/105; 134/182

(57) ABSTRACT

The present subject matter provides a dishwashing appliance having a flow of air through an air passageway defined between an inner panel and an outer panel of the dishwasher appliance. The inner panel has a condensation surface for assisting in drying dishes in the dishwasher appliance. A dampening baffle causes at least one change of direction in the flow of air through the air flow passageway.

### FIELD OF THE INVENTION

The subject matter of the present disclosure relates to a dishwasher appliance having a dampening baffle for directing a flow of air for heat exchange and/or sound dampening in the dishwasher appliance.

### BACKGROUND OF THE INVENTION

A design goal for current dishwasher appliances is to operate efficiently and quietly. Dishwasher appliances clean dishes disposed therein using a washing fluid (e.g., water and detergent) to remove debris and stains from the dishes. Thereafter, the dishes are rinsed with water to remove the washing fluid. After rinsing, the dishes can be dried by the dishwasher appliance, e.g., to avoid streaking or spotting on the dishes.

Conventionally, certain dishwasher appliances use a heating element (e.g., an electric resistance element) to dry the dishes after rinsing. However, such heating elements can consume a significant amount of energy. In addition, such dishwasher appliances must be vented to allow steam and humid air to escape the appliance. The steam and humid air exit the appliance at a vent. Such venting often results in poor energy efficiency due to the lost thermal energy.

In addition, dishwasher appliances are often located under a countertop within a set of kitchen cabinets. Such cabinets and countertops are often made of wood or other similar materials. Also, many kitchens have wood flooring beneath the dishwasher appliance. Around the vent, steam and humid air exiting the appliance can condense and drip onto the wood flooring potentially damaging it. Similarly, the steam and humid air exiting the appliance at the vent can potentially cause damage to the wooden cabinets or countertops housing the appliance.

Further, operation of dishwasher appliances can be noisy. For example, water impacting the sidewalls of the appliance during operation can generate an unappealing level of noise. For many consumers, an appliance's noisiness during operation is often an important distinguisher between competing appliances.

Accordingly, a dishwasher appliance that can dry dishes without the use of a heating element and associated vent for steam and water vapor would be useful. Further, a dishwasher appliance that can also operate more quietly would be particularly beneficial.

### BRIEF DESCRIPTION OF THE INVENTION

Aspects and advantages of the invention will be set forth in part in the following description, or may be obvious from the description, or may be learned through practice of the invention.

In a first embodiment, the present subject matter provides a dishwasher appliance. The dishwasher appliance has a cabinet with a wash chamber for the receipt of articles for cleaning. A rack assembly is slidably received into the wash chamber and configured for the receipt of the articles. The dishwasher appliance also includes a spray arm assembly for applying a fluid to the articles in the rack assembly. Further, the dishwasher appliance has an inner panel. The wash chamber of the cabinet is defined at least in part by the inner panel. The inner panel also provides a condensation surface for drying articles in the wash chamber. An outer panel is positioned adjacent to the inner panel so as to form an air flow passageway between the inner panel and the outer panel. The air flow passageway is fluidly connected with an air inlet and an air outlet in order to provide a flow of air from the exterior of the cabinet through the air flow passageway. A dampening baffle is located within the air flow passageway and extends between the outer panel and the inner panel. The dampening baffle is disposed so as to cause at least one change of direction in the flow of air through the air flow passageway.

In a second embodiment, the present subject matter provides a dishwasher appliance having a cabinet with a wash chamber for the receipt of articles for cleaning The wash chamber is defined at least in part by a panel assembly. The panel assembly has an inner panel positioned adjacent the wash chamber of the cabinet. The inner panel provides a condensation surface for drying articles in the wash chamber. The panel assembly also has an outer panel spaced apart from the inner panel. A dampening baffle extends between the outer panel and the inner panel. The inner panel, the outer panel, and the dampening baffle cooperate to form an air passageway. The air passageway extends between an air inlet and an air outlet. The air inlet receives air from an exterior of the cabinet in order to generate a flow of air through the air passageway that exits through the air outlet. The dampening baffle causes at least one change of direction in the flow of air in the air flow passageway. The dishwasher appliance also has a rack assembly slidably received into the wash chamber and configured for the receipt of the articles. Further, the dishwasher appliance has a spray arm assembly for applying a fluid to the articles in the rack assembly.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front view of a dishwasher appliance according to an exemplary embodiment of the present subject matter;

FIG. 2 provides a side, cross-sectional view of the exemplary dishwasher appliance of FIG. 1, particularly illustrating a wash chamber defined within the dishwasher appliance;

FIG. 3 illustrates a schematic representation of an exemplary panel assembly of the dishwasher appliance of FIG. 1 with dampening baffles disposed in an air passageway of the panel assembly.

### DETAILED DESCRIPTION OF THE INVENTION

The present subject matter provides a dishwashing appliance having a flow of air through an air passageway defined between an inner panel and an outer panel of the dishwasher appliance. The inner panel has a condensation surface for assisting in drying dishes in the dishwasher appliance. A dampening baffle causes at least one change of direction in the flow of air through the air flow passageway. Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

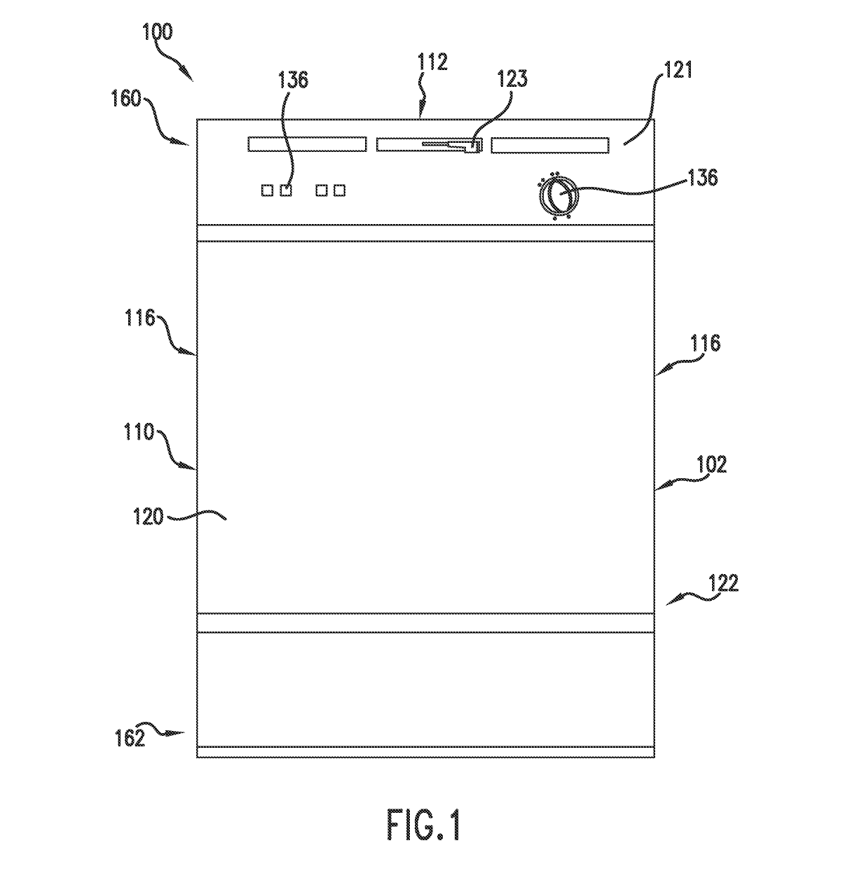

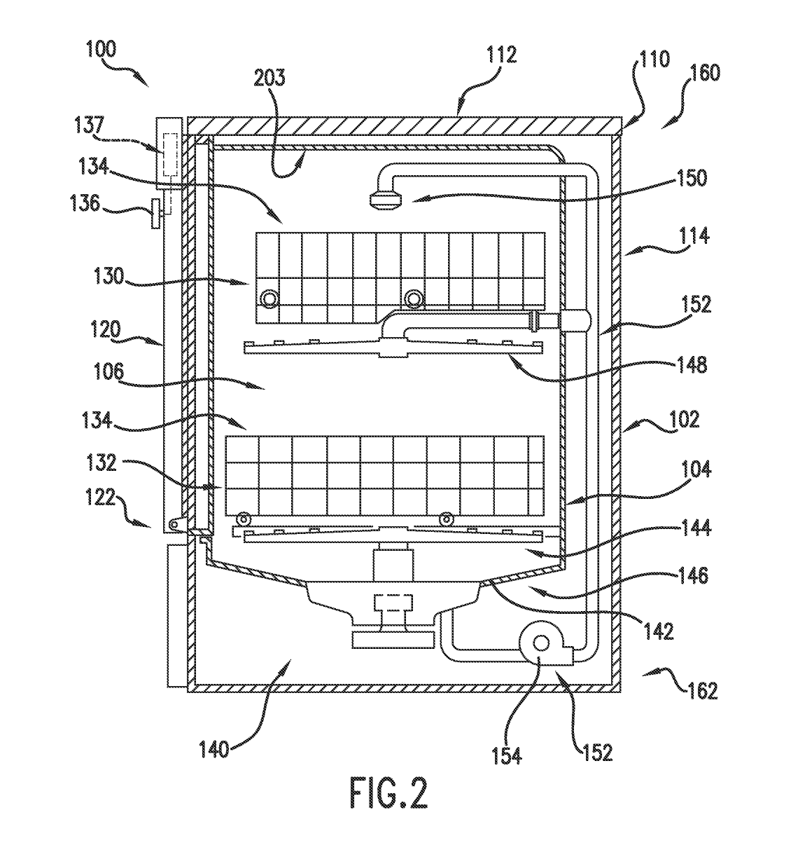

FIGS. 1 and 2 depict an exemplary domestic dishwasher appliance 100 that may be configured in accordance with aspects of the present disclosure. For the particular embodiment of FIG. 1, the dishwasher 100 includes a cabinet 102. The cabinet 102 has wall panels 110 that include a top panel 112, a back panel 114, and side panels 116. The side panels 116 are spaced apart such that the side panels 116 are substantially cofacing. The top panel 112 and the back panel 114 extend between the side panels 116. The cabinet 102 also has a tub 104 therein that defines a wash chamber 106. The tub 104 includes a front opening (not shown) and a door 120 hinged at its bottom 122 for movement between a normally closed, vertical position (shown in FIGS. 1 and 2), wherein the wash chamber 106 is sealed shut for washing operation, and a horizontal, open position for loading and unloading of articles from the dishwasher. Latch 123 is used to lock and unlock door 120 for access to chamber 106.

Rack assemblies 130 and 132 are slidably mounted within the wash chamber 106. Each of the rack assemblies 130, 132 is fabricated into lattice structures including a plurality of elongated members 134. Each rack 130, 132 is adapted for movement between an extended loading position (not shown) in which the rack is substantially positioned outside the wash chamber 106, and a retracted position (shown in FIGS. 1 and 2) in which the rack is located inside the wash chamber 106. A silverware basket (not shown) may be removably attached to rack assembly 132 for placement of silverware, utensils, and the like, that are otherwise too small to be accommodated by the racks 130, 132.

The dishwasher 100 further includes a lower spray-arm assembly 144 that is rotatably mounted within a lower region 146 of the wash chamber 106 and above a tub sump portion 142 so as to rotate in relatively close proximity to rack assembly 132. A mid-level spray-arm assembly 148 is located in an upper region of the wash chamber 106 and may be located in close proximity to upper rack 130. Additionally, an upper spray assembly 150 may be located above the upper rack 130.

The lower and mid-level spray-arm assemblies 144, 148 and the upper spray assembly 150 are fed by a fluid circulation assembly 152 for circulating water and dishwasher fluid in the tub 104. The fluid circulation assembly 152 may include a pump 154 located in a machinery compartment 140 located below the bottom sump portion 142 of the tub 104, as generally recognized in the art. Each spray-arm assembly 144, 148 includes an arrangement of discharge ports or orifices for directing washing liquid onto dishes or other articles located in rack assemblies 130 and 132. The arrangement of the discharge ports in spray-arm assemblies 144, 148 provides a rotational force by virtue of washing fluid flowing through the discharge ports. The resultant rotation of the lower spray-arm assembly 144 provides coverage of dishes and other dishwasher contents with a washing spray.

The dishwasher 100 is further equipped with a controller 137 to regulate operation of the dishwasher 100. The controller may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor.

The controller 137 may be positioned in a variety of locations throughout dishwasher 100. In the illustrated embodiment, the controller 137 may be located within a control panel area 121 of door 120 as shown. In such an embodiment, input/output (“I/O”) signals may be routed between the control system and various operational components of dishwasher 100 along wiring harnesses that may be routed through the bottom 122 of door 120. Typically, the controller 137 includes a user interface panel 136 through which a user may select various operational features and modes and monitor progress of the dishwasher 100. In one embodiment, the user interface 136 may represent a general purpose I/O (“GPIO”) device or functional block. In one embodiment, the user interface 136 may include input components, such as one or more of a variety of electrical, mechanical or electro-mechanical input devices including rotary dials, push buttons, and touch pads. The user interface 136 may include a display component, such as a digital or analog display device designed to provide operational feedback to a user. The user interface 136 may be in communication with the controller 137 via one or more signal lines or shared communication busses.

It should be appreciated that the invention is not limited to any particular style, model, or other configuration of dishwasher, and that the embodiment depicted in FIGS. 1 and 2 is for illustrative purposes only. For example, instead of the racks 130, 132 depicted in FIG. 1, the dishwasher 100 may be of a known configuration that utilizes drawers that pull out from the cabinet and are accessible from the top for loading and unloading of articles. Also, the dishwasher 100 may not include an external cabinet and may, instead, include a wash chamber or tub mounted to a chassis that is not provided with external cabinetry other than the door. Other configurations may be used as well.

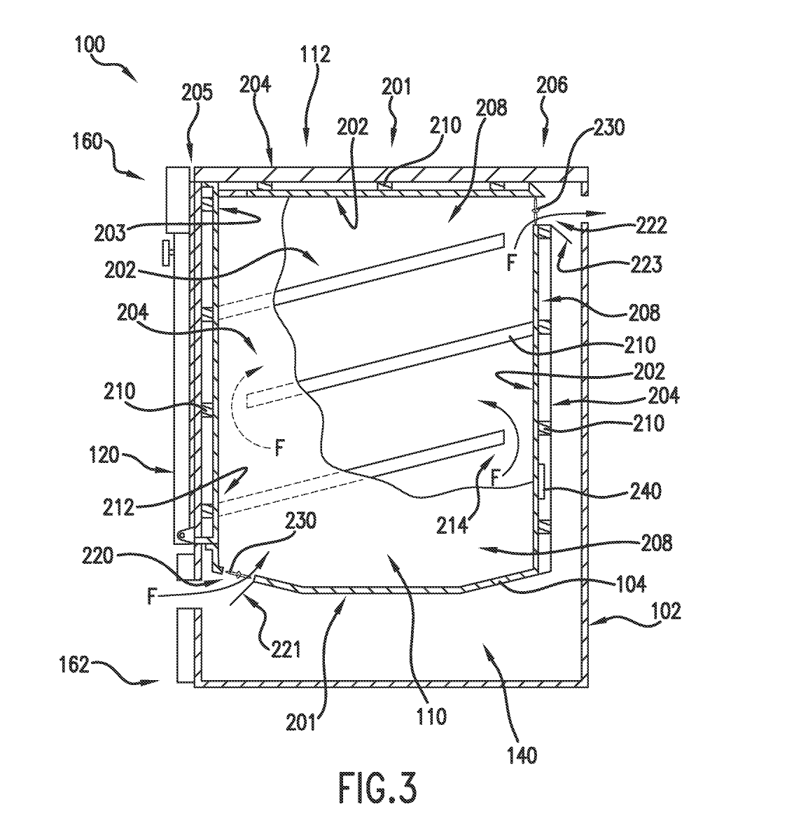

FIG. 3 illustrates a schematic representation of exemplary panel assemblies 201 of the dishwasher appliance 100 of FIG. 1. Each panel assembly 201 has an inner panel 202 and an outer panel 204 Inner panel 202 and outer panel 204 are spaced apart such that an air passageway 208 is defined by inner panel 202 and outer panel 204. Air passageway 208 extends between an inlet 220 and an outlet 222. Inlet 220 is in flow communication with outlet 222 through air passage way 208. Thus, air passageway 208 is configured for receiving air at inlet 220 and directing a flow of air F from inlet 220 to outlet 222.

Baffles 210 extend between inner panel 202 and outer panel 204 in air passageway 208. Baffles 210 cooperate with inner panel 202 and outer panel 204 to direct the flow of air as indicated by arrows F. Thus, as may be seen in FIG. 3, baffles 210 cause at least one change of direction in flow of air F through air passageway 208. Each one of baffles 210 may extend (e.g., longitudinally) between a first end 212 and a second end 214. At least one of the first ends 212 of baffles 210 may be positioned adjacent a first side 205 of panel assembly 201 with second end 214 of baffle 210 disposed within air passage way 208. Similarly, at least one of the first ends 212 of baffles 210 may be positioned adjacent a second side 206 of panel assembly 201 with second end 214 of baffle 210 disposed within air passage way 208.

As shown in FIG. 3, panel assemblies 201 may define at least in part door 120, wall panels 110, and/or tub 104 Inner panel 202 may be positioned adjacent wash chamber 106 (shown in FIG. 2) in order to provide a condensation surface 203 in an interior of tub 104. Outer panel 204 may be positioned adjacent cabinet 102, e.g., as shown in FIG. 3 with top panel 112. Alternatively, appliance 100 may not have an exterior cabinet. Regardless, the inner and outer panels 202,204 form air passageway 208 on one or more sides of appliance 100 with the inner panel 202 forming wash chamber 106 of appliance 100 and providing condensation surface 203 in wash chamber 106.

In FIG. 3, baffles 210 are slightly angled with respect to the horizontal direction. However, in alternative embodiments, baffles 210 may be substantially vertical or have any other suitable orientation within air passageway 208. Also, in FIG. 3, baffles 210 are substantially parallel. However, in alternative embodiments, baffles 210 may be disposed such that baffles 210 are not substantially parallel.

A first air flow regulator mechanism 221 is positioned adjacent inlet 220. Similarly, a second air flow regulator mechanism 223 is positioned adjacent outlet 222. First and second air flow regulator mechanisms 221,223 are configured for selectively obstructing flow of air F through air passageway 208. The first and second air flow regulator mechanisms 221,223 may be valves, flaps, or any other mechanism suitable for adjusting (e.g., allowing or terminating) flow of air F through air passageway 208. In addition, a fan 230 may be disposed within air passageway 208 in order to selectively assist the flow of air F in air passageway 208.

During certain cycles of operation, dishwasher appliance 100 could be noisy. For example, during a rinse cycle, water from spray arm assemblies 144, 148, or 150 can impact tub 142 and thereby create loud noises and/or vibrations. In order to reduce noise and/or vibrations emanating from dishwasher appliance 100 during operation, first and second air flow regulator mechanisms 221,223 are closed (i.e., first and second air flow regulator mechanisms 221,223 obstruct flow of air F in air passageway 208). By closing first and second air flow regulator mechanisms 221,223, air confined within air passageway 208 dampens noise and/or vibrations coming from dishwasher appliance 100. In FIG. 3, baffles 210 are constructed of noise and/or vibration dampening material (e.g., a porous absorber, foam, or a resonant absorber). Because baffles 210 are constructed of dampening material, baffles 210 also dampen noise and/or vibrations emanating from dishwashing appliance 100.

Prior to removing washed articles from wash chamber 106, the articles may be dried. After a wash cycle, articles in chamber 106 are rinsed with relatively high temperature water to remove wash fluid from the articles. Thus, articles and chamber 106 are at a higher temperature than room temperature ambient air. In addition, air in chamber 106 has high moisture content.

To dry the articles, first and second air flow regulator mechanisms 221,223 are opened (i.e., first and second air flow regulator mechanisms 221,223 permit flow of air (shown by arrows F) in air passageway 208. Thus, room temperature ambient air from an exterior of cabinet 102 enters air passageway 208 at inlet 220 and flows to outlet 222. Flow of air F cools inner panel 202 as flow of air F passes over inner panel 202. In turn, air in chamber 106 contacts inner panel 202 which has a temperature less than or equal to the dew point of the air in chamber 106 due to flow of air F. Accordingly, water from air in chamber 106 condenses on a relatively cool condensation surface 203 of inner panel 202. Because the condensed water is removed from the air in the chamber 106, the relative humidity of the air in the chamber 106 is lowered. In turn, because of the decreased relative humidity, air in the chamber 106 can absorb additional moisture from elsewhere in the chamber 106 (e.g. moisture or water disposed on the articles drying in the chamber 106).

As the flow of air F passes through the air passageway 208, thermal energy from chamber 106 passes to flow of air F in air passageway 208. Thus, flow of air F increases in temperature. In FIG. 3, such increase in temperature assists the flow of air F through air passageway 208 because air rises as it increases in temperature, and inlet 220 is positioned adjacent a bottom 162 of cabinet 102 and outlet 222 is positioned adjacent a top 160 of cabinet 102. However, fan 230 may also be used to assist flow of air F through air passageway 208.

To increase the capacity of dishwasher appliance 100 to dry articles in wash chamber 106, a heat sink 240 may be disposed within air passageway 208 on inner panel 202. Heat sink may be a block of metal or any other suitable conductive material. In addition, inner panel 202 may be constructed of metal to assist in transferring thermal energy from chamber 106 to flow of air F.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwasher appliance comprising:
a cabinet having a wash chamber for the receipt of articles for cleaning,
a rack assembly slidably received into the wash chamber and configured for the receipt of the articles;
a spray arm assembly for applying a fluid to the articles in said rack assembly;
an inner panel, the wash chamber of said cabinet defined at least in part by said inner panel, said inner panel also providing a condensation surface for drying articles in the wash chamber;
an outer panel positioned adjacent to the inner panel so as to form an air flow passageway between said inner panel and said outer panel, the air flow passageway fluidly connected with an air inlet and an air outlet in order to provide a flow of air from the exterior of said cabinet through the air flow passageway; and
a dampening baffle located within the air flow passageway and extending between the outer panel and the inner panel, said dampening baffle disposed in the air flow passage way so as to cause at least one change of direction in the flow of air through the air flow passageway.

2. The dishwasher appliance of claim 1, wherein the inlet is positioned adjacent a bottom of said cabinet and the outlet positioned adjacent a top of said cabinet.

3. The dishwasher appliance of claim 1, wherein the air flow passageway has a first air flow regulator mechanism positioned adjacent the inlet of the air flow passageway, and the air flow passageway also has a second air flow regulator mechanism positioned adjacent the outlet of the air flow passageway, the first and second air flow regulator mechanisms configured for selectively obstructing the flow of air through the air flow passageway.

4. The dishwasher appliance of claim 1, further comprising a fan disposed within the air flow passageway in order to selectively facilitate the flow of air through the air flow passageway.

5. The dishwasher appliance of claim 1, further comprising an additional dampening baffle located within the air flow passageway and extending between the outer panel and the inner panel, said additional dampening baffle disposed so as to cause at least one change of direction in the flow of air through the air flow passageway.

6. The dishwasher appliance of claim 5, wherein said dampening baffle and said additional dampening baffle are substantially parallel.

7. The dishwasher appliance of claim 5, wherein said outer panel has a first side and a second side, said dampening baffle extending from the first side of said outer panel towards the second side of said outer panel, said additional dampening baffle extending from the second side of said outer panel towards the first side of said outer panel.

8. The dishwasher appliance of claim 1, wherein said inner panel is comprised of a metal.

9. The dishwasher appliance of claim 1, further comprising a heat sink disposed within the cavity and positioned adjacent the inner panel.

10. The dishwasher appliance of claim 1, wherein the outer and inner panel form a wall of the dishwasher appliance.

11. The dishwasher appliance of claim 1, wherein the outer and inner panel form a door of the dishwasher appliance.

12. A dishwasher appliance comprising:
a cabinet having a wash chamber for the receipt of articles for cleaning, the wash chamber defined at least in part by a panel assembly, the panel assembly comprising:
an inner panel positioned adjacent the wash chamber of said cabinet, said inner panel providing a condensation surface for drying articles in the wash chamber;
an outer panel spaced apart from said inner panel; and
a dampening baffle extending between said outer panel and said inner panel, wherein:
said inner panel, said outer panel, and said dampening baffle cooperate to form an air passageway, the air passageway extending between an air inlet and an air outlet, the air inlet receiving air from an exterior of said cabinet to generate a flow of air through the air passageway that exits the air flow passageway through the air outlet, said dampening baffle causing at least one change of direction in the flow of air in the air flow passageway; and
a rack assembly slidably received into the wash chamber and configured for the receipt of the articles; and
a spray arm assembly for applying a fluid to the articles in said rack assembly.

13. The dishwasher appliance of claim 12, wherein the air inlet is positioned adjacent a bottom of said cabinet and the air outlet positioned adjacent a top of said cabinet.

14. The dishwasher appliance of claim 12, wherein the air flow passageway has a first air flow regulator mechanism positioned adjacent the air inlet of the air flow passageway, and the air flow passageway also has a second air flow regulator mechanism positioned adjacent the air outlet of the air flow passageway, the first and second air flow regulator mechanisms configured for selectively obstructing the flow of air through the air flow passageway.

15. The dishwasher appliance of claim 12, further comprising a fan disposed within the air flow passageway in order to selectively facilitate a flow of air through the air flow passageway.

16. The dishwasher appliance of claim 12, wherein said inner panel is comprised of a metal.

17. The dishwasher appliance of claim 12, further comprising a heat sink disposed within the air flow passageway and positioned on the inner panel.

18. The dishwasher appliance of claim 12, wherein the panel assembly of said cabinet forms a wall of said cabinet.

19. The dishwasher appliance of claim 12, wherein the panel assembly of said cabinet forms a door of said cabinet.
